(19) United States
(12) Patent Application Publication
(10) Pub. No.: US 2024/0404130 A1
(43) Pub. Date: Dec. 5, 2024

(54) RECONSTRUCTION METHOD FOR DVT WITH MOTION ARTIFACT REDUCTION

(71) Applicants: DENTSPLY SIRONA Inc., York, PA (US); SIRONA DENTAL SYSTEM GMBH, Bensheim (DE)

(72) Inventors: Markus HÜLSBUSCH, Bensheim (DE); Susanne MAUR, Bensheim (DE)

(73) Assignee: DENTSPLY SIRONA Inc., York, PA (US)

(21) Appl. No.: 18/690,934

(22) PCT Filed: Sep. 13, 2022
(86) PCT No.: PCT/EP2022/075350

§ 371 Date: Mar. 11, 2024

(30) Foreign Application Priority Data
Sep. 14, 2021 (EP) 21196486.1

(51) Int. Cl. G06T 11/00

(52) U.S. Cl. CPC G06T 11/006; G06T 11/005; G06T 2211/424; G06T 2211/448

(57) ABSTRACT

A computer-implemented method for reconstructing a dental DVT image, including: (S1) providing a sinogram acquired through an extraoral dental X-ray device during a rotation of at least 180 degrees around a patient's head and an initial projection geometry; (S2) geometry calibration through varying the projection geometry and evaluating the varied projection geometry using data consistency constraints derived from a first volume generated from the sinogram using the varied projection geometry in a first reconstruction method, the first reconstruction method using first reconstruction parameters; (S3) generating a final volume with a final reconstruction method using the varied projection geometry and final reconstruction parameters from the sinogram, the first reconstruction parameters of the first reconstruction method and the final reconstruction parameters of the final reconstruction method differing in at least one reconstruction parameter.

The entire content of the priority application EP21196486.1 is hereby incorporated by reference to this international application under the provisions of the PCT.

### TECHNICAL FIELD OF THE INVENTION

The present invention relates to a system and a method, in particular a reconstruction method, inter alia, for geometric calibration of a digital volume tomography (DVT) image in the dental field for compensation of motion artifacts in the reconstructed volume.

### BACKGROUND OF THE INVENTION

Generally, in a DVT scan, as in a Cone Beam (CB) CT scan, the imaging components of the X-ray device, X-ray source and X-ray detector, face each other and rotate around the patient. This produces a sequence of X-ray projections that vary in acquisition time and projection angle. These form a sinogram. Usually, according to a reconstruction method, knowing the projection geometry, a volume is reconstructed from the sinogram, which is displayed for diagnosis. The projection geometry describes the geometric properties of the X-ray device and its trajectory during the exposure. It can be expressed by means of projection matrices. Alternatively, other known forms of representation can be used.

If the patient moves during the DVT scan or if the calibration of the X-ray unit is outdated, an unsuitable projection geometry is used in the reconstruction process. This leads to motion artifacts in the reconstructed volume due to the accounting of inconsistent data. As a countermeasure, a motion artifact compensation (MAC) method, or geometric calibration of the scan, is generally used, which estimates the projection geometry from a given patient scan by evaluating data consistency.

Most known MAC methods also use a reconstruction procedure internally to evaluate data consistency using a reconstructed volume. Here it is common to use the same reconstruction method with the same reconstruction parameters as used for the reconstruction of the volume for diagnosis. Some known MAC methods also generate a volume as output, which can also be used directly for diagnosis as an alternative.

In general, MAC methods are computationally intensive and therefore lead to long computing times. They are also often not robust in their results, because image artifacts can influence the result.

### DISCLOSURE OF THE INVENTION

The inventors are not aware of any imaging technique in the prior art that uses separate reconstruction methods for the geometric calibration and the generation of the final volume, respectively, which are individually adapted to these different purposes and thus the overall process can be flexibly and independently optimized in terms of speed/resource consumption and image quality.

The objective of the present invention is to provide a method for reconstructing a DVT image in the dental field using a motion artifact compensation method.

This objective is achieved by the method according to claim 1. The subject-matters of the dependent claims relate to preferred embodiments and further developments.

The computer-implemented method according to the invention is used to reconstruct a DVT image in the dental area. It comprises the following steps: providing a sinogram acquired through an extraoral dental x-ray device during a rotation of at least 180 degrees around a patient's head and an initial projection geometry; geometrical calibration through varying the projection geometry and evaluating the varied projection geometry using data consistency constraints derived from a first volume generated from the sinogram using the varied projection geometry in a first reconstruction method, wherein the first reconstruction method uses first reconstruction parameters; generating a final volume with a final reconstruction method using the varied projection geometry and final reconstruction parameters from the sinogram, wherein the first reconstruction parameters of the first reconstruction method and the final reconstruction parameters of the final reconstruction method differ in at least one reconstruction parameter.

A major advantageous feature of the present invention is the use of two different reconstruction methods. A significant advantageous effect of the present invention is that the reconstruction methods can be optimized for the particular application.

The first reconstruction method is adapted for a reduced computation time and/or a robust result of the MAC method. In particular, this can be achieved by a lower resolution or a smaller size of the first volume or by a coarser temporal or spatial subsampling of the sinogram. In particular, the size and location of the first volume can also be limited to suitable anatomical structures, or the size and location of the first volume can be extended to structures outside the fully imaged region. In particular, the aforementioned goals can also be achieved by adding or omitting or differently implementing or parameterizing data processing or correction steps.

The final reconstruction procedure is adapted for the calculation of a volume with optimal, usual and/or user-configurable image impression for diagnosis. In particular, this can be achieved by an appropriate choice of resolution, size and location of the first volume, which are conditioned by the projection geometry during the DVT acquisition and the compatible resolution of the X-ray projections. In particular, the use of all appropriate information of the sinogram is carried out. In particular, the image impression can also be achieved by adding or omitting or different implementation or parameterization of data processing or correction steps.

### BRIEF DESCRIPTION OF THE DRAWINGS

In the following description, the present invention will be explained in more detail by means of exemplary embodiments and with reference to the drawings, wherein

FIG. 1—shows a schematic diagram of an extraoral X-ray system according to one embodiment;

FIG. 2—shows a flow diagram according to one embodiment of the invention;

FIG. 3—shows a flow diagram according to another embodiment of the invention.

The reference numbers shown in the drawings designate the elements listed below, which are referred to in the following description of the exemplary embodiments.
1. Extraoral X-ray system
2. X-ray device
3. X-ray tube
4. X-ray detector
5. Operating (control) unit
6. Head fixation
7. Bite block
8. Computer
9. Display

The computer-implemented method is for reconstructing a DVT image in the dental region. The method comprises the steps of: (S1) providing a sinogram acquired through an extraoral dental X-ray device (2) during a rotation of at least 180 degrees around a patient's head and an initial projection geometry; (S2) geometric calibration through varying the initial projection geometry and evaluating the varied projection geometry using data consistency constraints derived from a first (initial) volume generated from the sinogram using the varied projection geometry in a first (initial) reconstruction method, wherein the first reconstruction method uses first reconstruction parameters; (S3) generating a final volume from the sinogram by a final reconstruction method using the varied projection geometry and final reconstruction parameters, wherein the first reconstruction parameters of the first reconstruction method and the final reconstruction parameters of the final reconstruction method differ in at least one reconstruction parameter.

In a preferred embodiment, at least one of the first reconstruction parameters describes the resolution of the first volume. And at least one of the final reconstruction parameters describes the resolution of the final volume. The resolution of the first volume is different from the resolution of the final volume and is preferably lower. The lower resolution of the first volume reduces the computation time of the first reconstruction method and possible subsequent computation operations in the MAC process. Thus, the computation time of the overall MAC process is significantly reduced. Lower resolution of the first volume leads to more averaging of the information from the individual X-ray projections, so that the signal noise and other typical image artifacts of DVT imaging are attenuated. This increases the robustness of the MAC process against image artifacts. The resolution of the first volume can often also be used to influence the accuracy of the MAC process. A lower resolution allows correction of large motion errors, whereas a high resolution allows correction of small motions. For this purpose, the resolution of the first volume can also be chosen higher than the resolution of the final volume. The optimal resolution of the final volume usually results from the compatible system resolution of the X-ray device, which is defined by the technical properties of the imaging components such as the x-ray tube and x-ray detector and the geometry and trajectory of the X-ray device.

In another preferred embodiment, at least one of the first reconstruction parameters describes a first temporal subsampling of the sinogram. And at least one of the final reconstruction parameters describes a second temporal subsampling of the sinogram. The first temporal subsampling of the sinogram is different from the second temporal subsampling of the sinogram and is preferably coarser. The coarser first temporal subsampling of the sinogram reduces the computation time of the first reconstruction method, and thus reduces the computation time of the MAC process. The image artifacts possibly resulting from the coarser first temporal subsampling can be mitigated by suitable image processing methods, for example by a smoothing filter, in order not to impair the robustness of the MAC method. The temporal subsampling of the sinogram can be performed by selecting the projection angles used. The temporal subsampling can be a regular sampling, for example by selecting every second projection image, or it can be the selection of an angular range, for example an angular range with particularly much or little motion. The second temporal subsampling usually uses all projection images so that the final volume provides the best image impression for diagnosis and fully represents the acquired information.

In another preferred embodiment, at least one of the first reconstruction parameters describes a first local subsampling of the sinogram. And at least one of the final reconstruction parameters describes a second local subsampling of the sinogram. The first local subsampling of the sinogram is different from the second local subsampling of the sinogram and is preferably coarser. The coarser first local subsampling of the sinogram reduces the computation time of the first reconstruction method, and thus reduces the computation time of the MAC process. The local subsampling of the sinogram should be matched to the resolution of the respective volume. The local subsampling of the sinogram can be done by selecting or interpolating the pixel information used. The second local subsampling usually uses all pixel information so that the final volume provides the best image impression for diagnosis and completely represents the acquired information.

In another preferred embodiment, at least one of the first reconstruction parameters describes the size and/or location of the first volume. And at least one of the final reconstruction parameters describes the size and/or location of the final volume. The size and/or location of the first volume is different from the size and/or location of the final volume. According to a first alternative, preferably the size of the first volume may be smaller, which has the advantage of reduced computation time. In addition, the first volume may be limited to one or more regions with much or little motion or to regions that contain suitable anatomical structures for the MAC process. This increases the robustness and/or improves the convergence of the MAC process. According to a second alternative, the size of the first volume may be larger than the size of the final volume. This allows the consideration of suitable anatomical structures outside the fully acquired region in the MAC process. This offers the advantage of better convergence or a more robust result of the MAC process. The disadvantages of increased computation time can be compensated by reducing the volume resolution or subsampling of the sinogram. The size and/or location of the final volume can be chosen to suit the diagnosis. In most cases, the final volume comprises the entire fully acquired region, which has been acquired in a sufficient angular range, for example in an angular range of at least 180° rotation. The final volume is usually not extended to regions outside of the fully acquired region, since angle-dependent image artifacts occur there. A MAC process can partially compensate for angle-dependent image artifacts when evaluating the first volume. Preferably, the location of the first volume comprises at least one partially toothed region. The location of the said volumes may be determined by translation and/or rotation.

When a DVT image of a patient is taken, a wide variety of image artifacts can occur in a reconstructed volume. Some of these image artifacts primarily affect the robustness of the MAC process, while others primarily affect the diagnosis. For reasons of runtime and robustness of the MAC process, in the following embodiments the image artifacts as well as the image contents are treated differently in the first reconstruction method and in the final reconstruction method. Relevant image artifacts here include: Cupping artifacts due to beam hardening, metal artifacts due to highly absorbing materials, windmill artifacts due to angular under sampling, noise due to low dose, streak artifacts due to highly absorbing materials or scattered radiation or various other causes, truncation artifacts due to the limited size of the acquisition volume, cone beam artifacts due to the acquisition geometry of the X-ray device for DVT scans, motion artifacts due to patient motion or incorrect calibration of the X-ray device.

In another preferred embodiment, the first reconstruction method includes a step for correcting image artifacts, but the final reconstruction procedure does not include the same correction step. The additional step for correcting image artifacts improves the convergence of the MAC process. For example, image artifacts can be suppressed by smoothing the first volume, thus simplifying the evaluation of the data consistency of the first volume. The same step of correcting image artifacts is not applied in the final reconstruction procedure in order to achieve the best image impression for diagnosis in the final volume and to present the acquired information as unaltered as possible.

Alternatively, the final reconstruction method includes an image artifact correction step, and the first reconstruction method does not include the same correction step. Omitting the correction step in the first reconstruction method results in a reduced computation time of the first reconstruction method. In the final reconstruction method, computational time is often not as critical as in the first reconstruction method, so any correction steps that improve the image impression for diagnosis can be performed. Alternatively, both of the first reconstruction method and the final reconstruction method each include a step for correcting image artifacts, where they are different, or each include the same step for correcting image artifacts, but they are parameterized differently. If different steps are used to correct the same image artifacts, the correction step in the first reconstruction method can be optimized for computation time or convergence of the MAC process, and the correction step in the final reconstruction method can be optimized for the best image impression. If the same correction steps are used in both reconstruction methods with different parameterization, the parameterization in the first reconstruction method can be optimized for computing time or convergence of the MAC process and the parameterization in the final reconstruction method can be optimized for image impression.

In another preferred embodiment, the image artifact correction step is used to reduce metal artifacts or cone beam artifacts or scattered beam artifacts. These correction steps usually require a long computation time to achieve good correction results. Preferably, therefore, in the first reconstruction method, a correction step is selected or parameterized to have a low runtime. Alternatively, the strength or quality of the correction step is adjusted to cause low computation time or good convergence of the MAC process. Alternatively, the correction step is not used at all in the first reconstruction procedure to reduce the computation time of the MAC process. Preferably, in the final reconstruction method, the correction step is selected or parameterized to improve the image impression for diagnosis.

In another preferred embodiment, the final reconstruction method includes a step for post-processing the final volume, whereas the first reconstruction method does not include the same post-processing step. This offers the advantage that in the first reconstruction method, the omission of the said step reduces computational time, whereas in the final reconstruction method, the said step improves the image impression for diagnosis. An example of a post-processing step for the final volume is a gray level adjustment for presentation and comparability in the display or a noise reduction or a contrast enhancement. These are essentially not required for the intended use of the first volume in the MAC process. Alternatively, both the first reconstruction method and the final reconstruction method each include a post-processing step for the first volume and the final volume, where these are different, or each includes the same post-processing step but these are parameterized differently. Preferably, in the first reconstruction method, a post-processing step is to be selected or parameterized to have a short run time. Preferably, in the final reconstruction method, the post-processing step is to be selected or parameterized to improve the image impression for diagnosis.

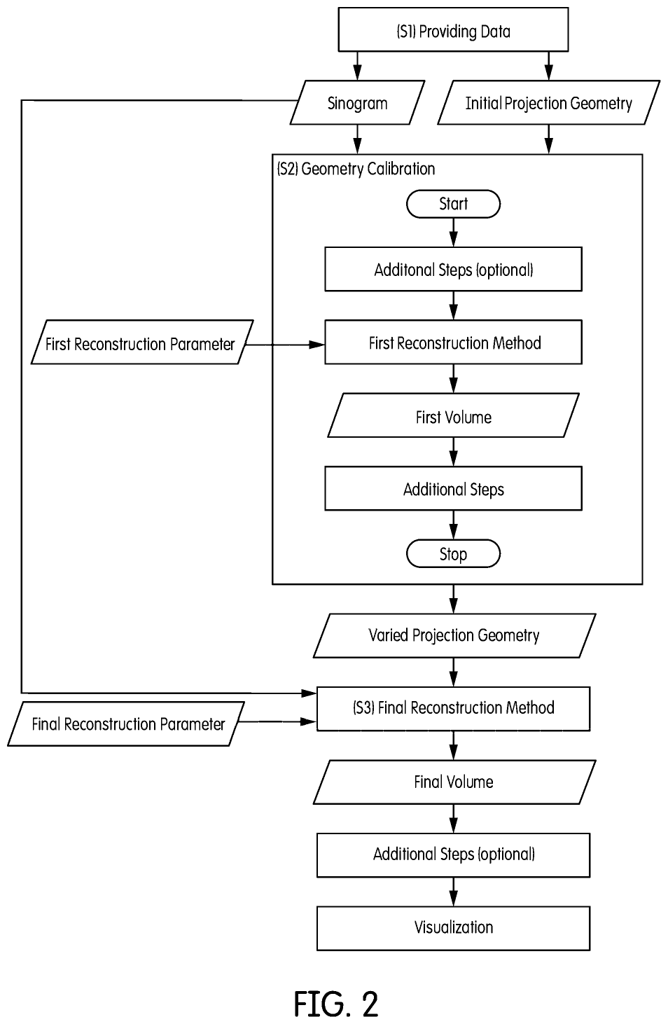

FIG. 2 shows another preferred embodiment in which the first reconstruction method includes a step of pre-processing the sinogram or post-processing the first volume, but the final reconstruction method does not include the same pre-processing or post-processing step with regard to the final volume. Pre-processing the sinogram, such as smoothing or edge-preserving smoothing, results in a reduction of noise and a reduction of small image artifacts in the first volume. A similar effect can be achieved by directly post-processing the first volume. These pre- and post-processing steps are beneficial in the first reconstruction method because they increase the robustness of the MAC process. Omitting these pre- and post-processing steps in the final reconstruction procedure results in a better image impression of the final volume for diagnosis and a more complete representation of the relevant information.

Alternatively, both the first reconstruction method and the final reconstruction method each include a step for pre-processing the sinogram or a step for post-processing the first and final volumes respectively, where these steps are different, or identical but differently parameterized. Preferably, in the first reconstruction method, the pre-processing and post-processing steps are chosen or parameterized to increase the robustness of the MAC process. Preferably, in the final reconstruction procedure, the steps for pre- and post-processing are to be selected or parameterized in such a way that the image impression for the diagnosis is improved and a complete representation of the relevant information is achieved.

In another preferred embodiment, the post-processing step is used for gray level adjustment, or edge-preserving smoothing or noise reduction.

In another preferred embodiment, the pre- and post-processing step is for noise reduction or edge-preserving noise reduction or edge enhancement or truncation artifact suppression.

In another preferred embodiment, the geometric calibration is an iterative process, where the image artifact correction step or its parameterization is changed during iterations. Some steps for correcting image artifacts require knowledge of the projection geometry to achieve a good correction result. If there are errors in the projection geometry, they provide worse or uncertain correction results. Also, the results of some steps for correcting image artifacts are relevant only when there is a small error in the projection geometry. In an iterative MAC process, it can be assumed that the errors of the projection geometry are reduced in each iteration. Thus, it is advantageous to adjust the image artifact correction step or its parameterization during the iterations. For example, the strength of the correction or the size of safety distances (e.g., the distance from a corrected region to an anatomical region) can be adjusted. Thus, the robustness and accuracy of the MAC process is increased or the computation time is reduced. In early iterations, the step for correcting image artifacts can be focused on correcting larger errors of the projection geometry, in late iterations, the step for correcting image artifacts can be focused on correcting smaller errors of the projection geometry.

In another preferred embodiment, the geometric calibration is an iterative process, where the pre-processing and post-processing step or its parameterization are changed during iterations. In an iterative MAC process, it can be assumed that the errors of the projection geometry are reduced in each iteration. Thus, the accuracy of the first volume increases in each iteration. This leads to a changed representation of the anatomical structures and possible image artifacts in the first volume. Adjusting the pre- and post-processing step or its parameterization during the iterations has the advantage of increasing the robustness and accuracy of the MAC process. In early iterations, the pre- and post-processing steps can be focused on correcting larger errors of the projection geometry, in late iterations, the pre- and post-processing steps can be focused on correcting smaller errors of the projection geometry.

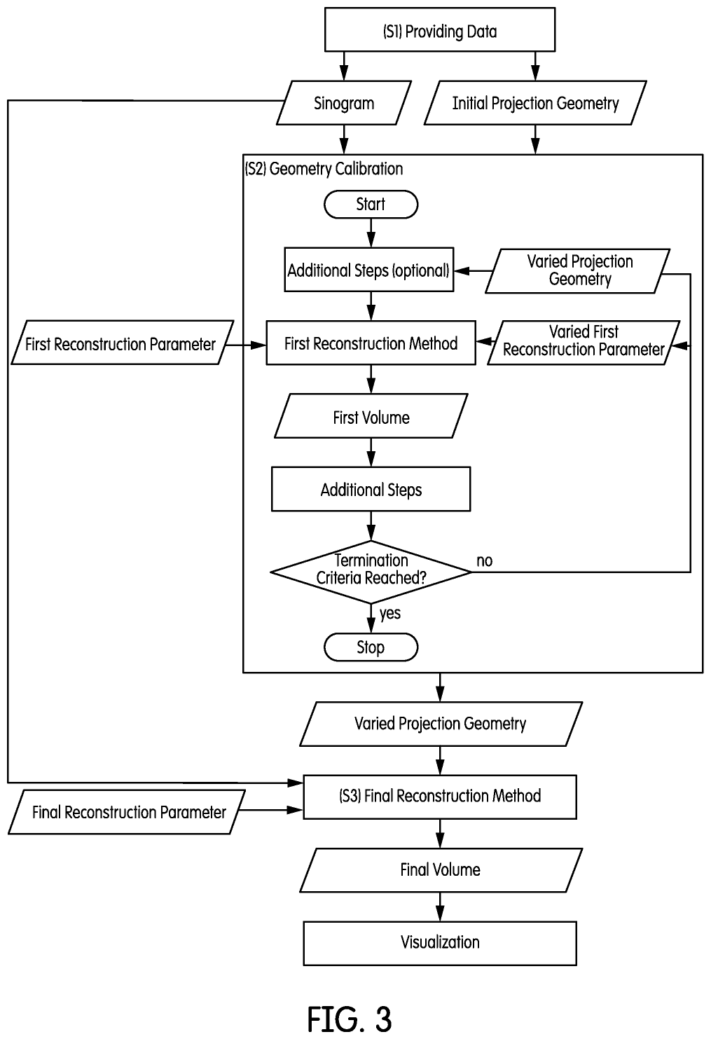

FIG. 3 shows another preferred embodiment in which the geometric calibration is an iterative procedure, with the initial reconstruction parameters being changed during the iterations. In an iterative MAC process, it can be assumed that the errors of the projection geometry are reduced in each iteration. Therefore, in later iterations, by adjusting the first reconstruction parameters, the detail representation in the first volume can be increased, thus improving the accuracy of the MAC process. In early iterations, on the other hand, it is beneficial to adjust the first reconstruction parameters for computation time reduction or robustness in the presence of large errors in the projection geometry of the MAC process. To achieve these goals, the resolution of the first volume is preferably increased during the iterations, the temporal and spatial subsampling of the sinogram is preferably reduced during the iterations, and the size and location of the volume is preferably adjusted from coarse anatomical structures to fine structures during the iterations. In summary, an iterative MAC process with increasing detail representation during the iterations allows for increased robustness of the MAC process with respect to movements of different sizes and reduces its computational time.

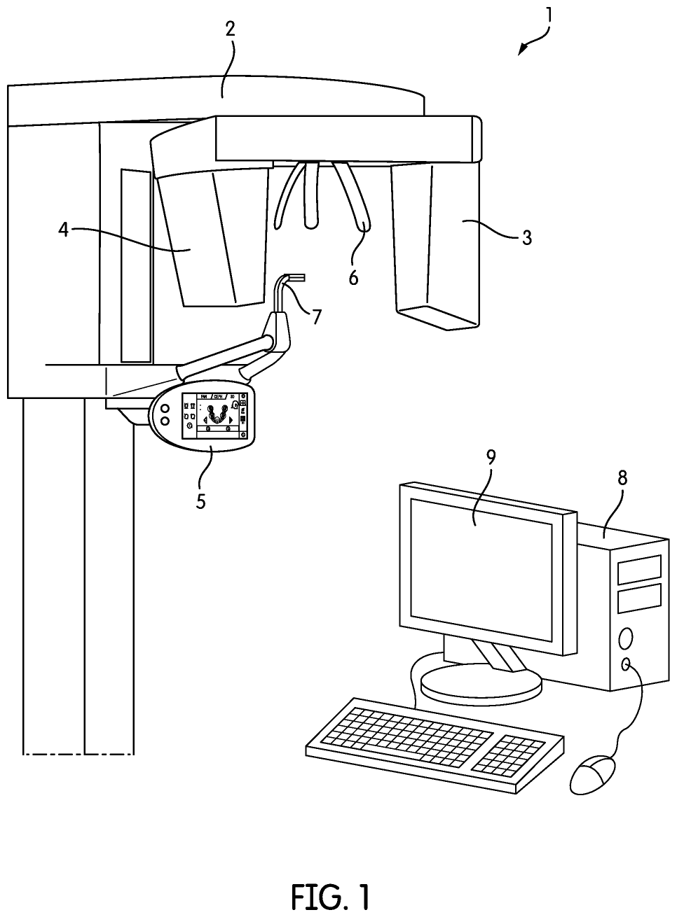

The method according to the invention is a computer-implemented method, and can be executed on a computer-assisted DVT system (1). FIG. 1 shows an implementation example for a DVT system (1). In this regard, the present invention also includes a computer program having computer-readable code. The computer program may be provided on a storage medium. The computerized DVT system (1) comprises an X-ray device (2) for performing patient imaging, and generating the 2D X-ray images or the sinogram. The X-ray device (2) has an X-ray tube (3) and an X-ray detector (4), which are rotated around the patient's head during the exposure. The trajectory of the X-ray tube (3) and X-ray detector (4) during the exposure may describe a circular path. Alternatively, it can assume a shape deviating from this. If several actuators are controlled simultaneously, a device trajectory around the patient's head that deviates from a pure circular path can be achieved. The patient's head is positioned in the X-ray device with the bite block (7) and the head fixation (6). The computerized DVT system (1) comprises an operating unit (5), preferably a computer (8) or a computing unit that can be connected to the X-ray device (2), and preferably a display (9), inter alia to visualize the data sets. The computer (8) may be connected to the X-ray device (2) via a local network (not shown) or alternatively via the Internet. The computer (8) may be part of a cloud. Alternatively, the computer (3) may be integrated into the X-ray device (2). The calculations may alternatively take place in the cloud. The computer (8) executes the computer program and provides the data sets, including for visualization on the display (9). The display (9) may be spatially separated from the X-ray device (2). Preferably, the computer (8) can also control the X-ray device (2). Alternatively, separate computers can be used for control and the reconstructions.

According to the present invention, the data sets generated by the above embodiments may be presented to a physician for visualization, in particular for diagnostic purposes, preferably by means of the display (9) or a printout.

### Reconstruction Methods

The first reconstruction method and the final reconstruction method may include the same or different reconstruction steps for generating the 3D volume from the sinogram. The reconstruction steps can be configured by different reconstruction parameters. The reconstruction step of the first reconstruction method could provide a comparatively low computational speed or a comparatively lower resource consumption. The reconstruction step of the final reconstruction method could enable comparatively improved image quality for diagnosis. In a preferred embodiment, both reconstruction methods comprise a Feldkamp reconstruction step. In a further embodiment, the first reconstruction method comprises a Feldkamp reconstruction step and the final reconstruction method comprises an algebraic reconstruction step, such as SART (simultaneous algebraic reconstruction technique) or an iterative reconstruction step. A reconstruction step can be described by a sequence of arithmetic operations. A reconstruction method usually includes several steps, such as steps for pre-processing the sinogram and post-processing the volume and reconstructing the volume.

### User Interaction

In a further embodiment, the reconstruction parameters, or the correction steps or their parameterization, or the pre- or post-processing steps or their parameterization for the final reconstruction procedure are adjustable by the user, for example via a user interface. This has the advantage that the user can set the desired image impression for the diagnosis. The same settings cannot be changed directly by the user for the first reconstruction method, since they are crucial for the result of the MAC process. However, they may depend on possible settings of the MAC process and thus be changed indirectly, such as the maximum correction accuracy, the size of the maximum correctable patient movements, or the maximum computing time of the MAC process. The user can be a physician who performs the diagnosis or the person who performs the DVT imaging on the X-ray device with the patient.

### Computer-Implemented Method

The initial reconstruction method and the final reconstruction method can be executed on the same hardware or on different hardware. The hardware may differ in its computing power, the size of its memory, or the location of its installation. The hardware may be located locally in or near the X-ray device or in a cloud. This offers the advantage that the hardware can be adapted to the respective different requirements of the two reconstruction methods. This saves computational time and the cost of purchasing or operating the hardware. The first reconstruction method and the final reconstruction method can both be performed on one or more CPUs and/or on one or more GPUs.

### Data Set Visualization/Diagnosis

The time of the calculation of step S3 can be significantly behind the time of the calculation of step S2 or both steps are executed directly one after the other. The final reconstruction method can also be executed several times. The significantly later execution of step S3 offers the advantage that the final volume can thus be subsequently adjusted. The adjustment is done by setting the reconstruction parameters or the correction steps or their parameterization or the pre- or post-processing steps or their parameterization for the final reconstruction procedure. This can be done manually by the user or automatically by software and serves to improve the display of the final volume for a special diagnosis or a special data export.

### Data Consistency Conditions

In one embodiment, geometric calibration is performed in step S2 by varying the projection geometry and evaluating the same using a similarity measure between a simulated sinogram of a first volume and the sinogram, wherein the simulated sinogram is calculated from the reconstructed first volume using the varied projection geometry and the first volume is calculated from the sinogram using the varied projection geometry with the first reconstruction method. Data consistency is achieved by using the similarity measure. Possible similarity measures or inverse error measures are: Mean Square Error, Mean Absolute Difference, Normalized Cross-correlation, Gradient Correlation, Gradient Information, Gradient Information with linear Scaling, Gradient Orientation, Mutual Information.

In another embodiment, geometric calibration is performed by varying the projection geometry and evaluating the same against an image quality metric on the first volume. Possible image quality metrics evaluate volume sharpness or volume contrast. They may be defined as sharpness metrics on the first volume, such as gradient variance or gradient norm, or defined by smoothness constraints on the first volume, such as the gray level entropy, the gray level variance, or the total variation.

In another embodiment, geometric calibration is performed by varying the projection geometry using an iterative reconstruction process that iteratively evaluates and reduces the difference between a simulated sinogram of the reconstructed first volume and sinogram using one of said similarity measures or error measures.

1. A computer-implemented method for reconstructing a dental DVT image:
(S1) providing a sinogram acquired through an extraoral dental X-ray device during a rotation of at least 180 degrees around a patient's head and an initial projection geometry;
(S2) performing geometry calibration through varying the projection geometry and evaluating the varied projection geometry using data consistency constraints derived from a first volume generated from the sinogram using the varied projection geometry in a first reconstruction method, wherein the first reconstruction method uses first reconstruction parameters;
(S3) generating a final volume with a final reconstruction method using the varied projection geometry and final reconstruction parameters from the sinogram, wherein the first reconstruction parameters of the first reconstruction method and the final reconstruction parameters of the final reconstruction method differ in at least one reconstruction parameter.

2. The method of claim 1, wherein the first reconstruction method and the final reconstruction method each include a reconstruction step configured by said at least one different reconstruction parameter, wherein the reconstruction step of the first reconstruction method is different from the reconstruction step of the final reconstruction method, wherein the reconstruction step of the first reconstruction method enables comparatively low computational speed or comparatively lower resource consumption or the reconstruction step of the final reconstruction method enables comparatively improved image quality for diagnosis.

3. The method of claim 1, wherein at least one of the first reconstruction parameters describes the resolution of the first volume and at least one of the final reconstruction parameters describes the resolution of the final volume, wherein the resolution of the first volume is different from the resolution of the final volume.

4. The method of claim 1, wherein at least one of the first reconstruction parameters describes a first temporal subsampling of the sinogram and at least one of the final reconstruction parameters describes a second temporal subsampling of the sinogram, wherein the first temporal subsampling of the sinogram is different from the second temporal subsampling of the sinogram.

5. The method of claim 1, wherein at least one of the first reconstruction parameters describes a first local subsampling of the sinogram and at least one of the final reconstruction parameters describes a second local subsampling of the sinogram, wherein the first local subsampling of the sinogram is different from the second local subsampling of the sinogram.

6. The method according to claim 1, wherein at least one of the first reconstruction parameters describes the size and/or position of the first volume and at least one of the final reconstruction parameters describes the size and/or position of the final volume, wherein the size and/or position of the first volume is different from the size and/or position of the final volume.

7. The method according to claim 1, wherein the first reconstruction method includes a step for correcting image artifacts and the final reconstruction method does not include the same correction step; or the final reconstruction method includes a step for correcting image artifacts and the first reconstruction method does not include the same correction step; or both of the first reconstruction method and the final reconstruction method each include a step for correcting image artifacts, wherein they are different, or each include the same step for correcting on image artifacts, wherein they are differently parameterized.

8. The method according to claim 7, wherein the step of correcting image artifacts reduces metal artifacts or cone beam artifacts or scattered beam artifacts.

9. The method according to claim 1, wherein the final reconstruction method includes a step for post-processing the final volume and the first reconstruction method does not include the same post-processing step; or both of the first reconstruction method and the final reconstruction method each include a step for post-processing the first and final volumes respectively, wherein these are different, or each include the same post-processing step, wherein these are differently parameterized.

10. The method according to claim 1, wherein said first reconstruction method includes a step of pre-processing said sinogram or post-processing said first volume and said final reconstruction method does not include the same pre-processing or post-processing step; or both of said first reconstruction method and said final reconstruction method each include a step of pre-processing said sinogram or post-processing said first volume and said final volume respectively, which are different, or each include the same pre-processing or post-processing step, wherein these are differently parameterized.

11. The method according to claim 9, wherein the post-processing step serves for gray value adjustment or edge-preserving smoothing or noise reduction.

12. The method according to claim 10, wherein said pre- and post-processing step is for noise reduction or edge-preserving noise reduction or edge enhancement or truncation artifact suppression.

13. The method according to claim 7, wherein the geometric calibration is an iterative method and the step for correcting image artifacts or its parameterization are changed during the iterations.

14. The method according to claim 9, wherein the geometric calibration is an iterative method and the pre- and post-processing step or its parameterization are changed during the iterations.

15. The method according to claim 1, wherein the geometric calibration is an iterative method and the first reconstruction parameters are changed during the iterations.

16. The non-transitory computer-readable medium storing instructions which, when executed by a computerized DVT system, causes the computerized DVT system to:
(S1) provide a sinogram acquired through an extraoral dental X-ray device during a rotation of at least 180 degrees around a patient's head and an initial projection geometry;
(S2) perform geometry calibration through varying the projection geometry and evaluating the varied projection geometry using data consistency constraints derived from a first volume generated from the sinogram using the varied projection geometry in a first reconstruction method, wherein the first reconstruction method uses first reconstruction parameters;
(S3) generate a final volume with a final reconstruction method using the varied projection geometry and final reconstruction parameters from the sinogram, wherein the first reconstruction parameters of the first reconstruction method and the final reconstruction parameters of the final reconstruction method differ in at least one reconstruction parameter.

17. (canceled)

18. The computerized DVT system comprising an X-ray device and a computing unit configured to
(S1) provide a sinogram acquired through an extraoral dental X-ray device during a rotation of at least 180 degrees around a patient's head and an initial projection geometry;
(S2) perform geometry calibration through varying the projection geometry and evaluating the varied projection geometry using data consistency constraints derived from a first volume generated from the sinogram using the varied projection geometry in a first reconstruction method, wherein the first reconstruction method uses first reconstruction parameters;
(S3) generate a final volume with a final reconstruction method using the varied projection geometry and final reconstruction parameters from the sinogram, wherein the first reconstruction parameters of the first reconstruction method and the final reconstruction parameters of the final reconstruction method differ in at least one reconstruction parameter.

19. (canceled)
